(19) United States
(12) Patent Application Publication
(10) Pub. No.: US 2006/0069607 A1
(43) Pub. Date: Mar. 30, 2006

(54) Transformation of organizational structures and operations through outsourcing integration of mergers and acquisitions

(75) Inventor: Jane C. Linder, Charlestown, MA (US)

Correspondence Address: ACCENTURE, LLP;C/O HOGAN & HARTSON, LLP (IPGROUP), 555 13TH STREET NW, SUITE 600E, WASHINGTON, DC, 20004, US

(73) Assignee: Accenture Global Services GmbH

(21) Appl. No.: 10/950,695

(22) Filed: Sep. 28, 2004

(51) Int. Cl. G06F 11/34

(52) U.S. Cl. 705/11

(57) ABSTRACT

Disclosed are tools and related methods for business organizations to quickly obtain, preserve and exploit new or improved assets, skills or capabilities that are important to growth and success. The tools and processes disclosed are adapted to preserve one or more target elements of an acquired target business organization by outsourcing those target elements during the integration period that follows the merger or acquisition. This outsourcing of one or more target elements during the integration period that necessarily follows a merger or acquisition deal creates various inherent advantages over the traditional merger, acquisition, or outsourcing approaches as described herein, and these advantages help to deliver benefits of the target element in speedy fashion and with undiminished quality.

### FIELD OF THE INVENTION

The present invention relates to methods for transforming the structures and operations of organizations, such as corporations and other business entities. More particularly, the present invention pertains to improved methods for business organizations to quickly obtain, preserve and exploit new or improved assets, skills or capabilities that are important to growth and success, which methods include acquiring or securing those capabilities through outsourcing.

### BACKGROUND OF THE INVENTION

The pace with which business is conducted and with which deals are transacted in modern economies exerts constant pressure upon business organizations, such as corporations or other business entities, to evolve their business models in response to market changes to avoid an increased risk of poor performance or even failure. Market changes can rapidly destabilize profit centers and create or expand cost centers, establishing a need for adaptation. Additionally, business organizations can have many structural features that create inherent problems over time. Past mergers, successive expansions, and other activities of such organizations can introduce and embed redundancies, incompatibilities, and inefficiencies into a business organization's business model.

Organizations that cannot successfully evolve their capabilities and business structures in pace with market changes eventually find themselves in a situation where they need to undergo a quick and successful transformation in order to survive and thrive in the evolved market. Transformation is the large-scale fundamental change to an organization's processes, technology, culture and/or way of doing business in an effort to improve the standing/health of the organization, such as by reducing costs, improving return-on-investment and/or creating skills or capabilities for new or modernized programs and services.

The objective of any business organization transformation is to adapt the organization such that it can better meet the various competitive challenges to the organization, including financial factors, customer needs, internal operations, and overall corporate organization. Financial objectives, for example, may include reducing overall expenditures, reducing non-discretionary expenditures, improving access to capital, and increasing the return on investment. Likewise, customer-based objectives may include improving the business organization's relationship with key customers and increasing the quality of services. Objectives for internal operations may include providing comprehensive management information sharing, ensuring smooth running of the organization, and using resources efficiently. Objectives for the overall corporate organization may include improving delivery capabilities for all products and services, and, in particular, for strategic programs and creating a change-ready culture. A transformation plan adopted by a business organization can include strategies directed to effect changes in any one of, or any combination of, these areas.

Since a business organization in need of strategic transformation inherently needs assets, skills or capabilities that it doesn't have, contemporary business tools used to implement transformation of business organizations, such as corporations or companies, include mergers and acquisitions, strategic partnerships, and outsourcing. Mergers and acquisitions are a common and longstanding approach to transformation taken by many companies. In such cases, the company seeks to maintain or enhance profitability by focusing upon finding key capabilities or resources that can be obtained from other companies to provide advantageous synergies. These synergies, for example, could provide beneficial economies of scale, or could provide vertical and horizontal integration with suppliers, distributors, or entities competing in or providing complementary goods or services to the same market. Corporate mergers and acquisitions (which may collectively hereafter be referred to as “mergers”) are commonplace occurrences in many of today's markets and industries and are becoming increasingly more frequent occurrences.

Importantly, however, mergers also are becoming progressively more complex as the involved companies of the modern economy become larger and more diverse. Mergers spurred on by a need or desire to transform a particular business organization can often cause the involved organization(s) to leverage much of its immediate and/or long term fiscal health and growth upon the expected benefits from the merger. Success of the deal thus becomes of paramount importance, and the management effort to make the deal successful can become a distraction to the day to day operations of the involved businesses.

Mergers, to be successful, often necessitate massive and invasive post-merger integration efforts by the remaining one or more companies or organizations. This not only requires reconciling pre-existing business goals and strategies taken from the original business entities with the adopted goals and strategies of the resulting organization(s), but also integrating operations and resources within the remaining organization(s). Merger integrations generally proceed through various different phases, each characterized by different goals, tasks and activities that must be managed appropriately in order for the merger to proceed successfully. These tasks and activities further the merging of organizations, cultures, and technologies to eliminate redundant resources, retain the best elements and processes from each of the original companies, and establish new elements and processes needed by the resulting organization(s). Notably, these post-merger integration activities can extend for months or even years. In a testament to the complexity of post-merger integration, many businesses commonly turn to external consulting firms or other specialists to evaluate proposed mergers, to assist in planning activities in an upcoming scheduled merger, and to manage the transition period for an ongoing merger.

This complexity of mergers in today's environment in many circumstances decreases the usefulness of mergers as a tool for driving transformation. Many academics and experienced business executives believe that the complexity and length of, and opportunities for management errors in, post-merger or post-acquisition integrations create an environment in which mergers and acquisitions almost inevitably and inherently destroy value that is present in the pre-merger entities. This destruction of value can manifest itself in various forms. For example, the sheer immensity of the merger undertaking can cause distracted managers to lose sight of emerging changes to the marketplace, to mistreat customers, or otherwise to lose those advantages that made the acquired or target company desirable or successful in the first place, leading the resulting company to fall behind. Further, on top of the financial and labor resources expended to merge the original business entities together, mergers can lead to the loss of key personnel who are made uneasy by organizational change.

Mergers as a tool for transformation also suffer from an inability to provide the desired capabilities, resources, or other competitive benefits (which may provide the actual driving impetus behind the merger) with sufficient speed. As noted above, merger integrations can span periods generally ranging well over a year. If, for example, an acquiring (or “acquiror”) organization wishes to transform its direct sales force, an attempt to transform by initiating a merger with another (“acquiree”) organization that has a particular strength in that area would not provide any benefits to the acquiror organization for at least several months, and likely not within a year. Further, once the acquiring business organization finally does start to receive the desired benefit from the acquired organization, it is possible that the desired benefit will be of a lesser or diminished value then what was originally anticipated due to above-described tendency for mergers to destroy value. Thus, mergers are not suitable as a tool for efficient transformation in many circumstances.

Outsourcing is a second tool that business organizations have used as an alternative to drive transformation by obtaining competitive business benefits from other business entities. Outsourcing can be generally defined as a type of transaction whereby a business organization contracts, or “outsources,” with one or more third party service provider organizations to put those provider organizations in charge of restructuring and/or managing certain designated service functionalities for the business organization. The outsourcing contract often establishes service requirements and predefined performance metrics that must be met by the service provider. The outsourcing services provider, due to competitive pressures, in turn feels the need to satisfy its customer, the business organization in need of transformation.

Various tasks and functions can be outsourced by business organizations, whereby the processes underlying those tasks and functions are implemented essentially independently by the services provider. Functionalities that are common candidates for outsourcing generally include administrative and support functions that fall outside of the business organization's core competencies. Such an arrangement benefits the client business organization to the extent that “experts” focusing their core business (i.e., the administrative or support functions) will do a better and/or cheaper job than internal departments or employees. The employees and managers of the outsourced service are considered to be core assets by the outsourcing service provider while they might otherwise be seen as merely a cost center if incorporated into a larger general business organization as an internal support center. Therefore, they are often treated and/or compensated as such, providing them with improved motivation to service their client and helping to retain the best personnel. Business organizations therefore rely upon outsourcing under the assumption that profit motive and customer satisfaction will entice such third party providers to improve quality of service and drive down the bottom line costs associated with performing these support functions (relative to managing these support functions internally).

Management of contemporary business organizations have begun to utilize outsourcing to address, for example, bloated cost centers that may have very little visibility into cost allocation and virtually no accountability when it comes to returning adequate value on investments. Since business organizations are always looking across their organization to identify ways to manage costs, outsourcing of various service functions (information technology, personnel and benefits, workforce training, etc.) has become more and more commonplace. Information technology support services in particular comprise one business support function that is being outsourced to third party providers on an increasingly more common basis.

Contemporary business and government organizations also use outsourcing to get access to technologies, skills, and capabilities that they do not currently possess, but which they need in order to execute their strategies. These capabilities could include almost any business skill, such as the ability to develop and deploy new information systems, the ability to manage professional selling, or the ability to research and develop new products and services. Outsourcing capabilities like these benefit the client business organization by enabling it to execute a new strategy necessitated by a changing business environment. Because the strategy is new, and requires new skills and capabilities, the business organization would not otherwise have access to these capabilities as quickly or as effectively if it had to develop them from scratch.

The primary advantage that outsourcing has over mergers as a tool for driving transformation of a business organization is that it can be implemented faster, leading to the organization feeling the benefits of this type of transformation delivery more quickly. Outsourcing, however, is not a perfect tool and can suffer from various drawbacks. First, outsourcing may not be an option in all circumstances if a suitable service provider could not be identified, such as, for example, where there are no suitable third party service providers that can deliver the required service because specialized knowledge is required by the particular business organization. Additionally, outsourcing would not deliver the other benefits achieved through merger or acquisition, such as the obtaining of market share, rights under existing contracts, and intellectual property, which may be essential to the organization's vision for the transformation. Further, business organizations can be altogether unwilling to utilize outsourcing in certain circumstances as a long term part of its business model for fear of divesting itself of direct supervisory control over a key function of its profitability model.

Therefore, there is a need for improved mechanisms for transforming a business organization that does not suffer from the above mentioned problems. A mechanism that provides relatively fast realization of certain target desired capabilities to the organization while allowing the benefits of a traditional merger or acquisition would be beneficial. Further, mechanisms for limiting the destruction of value during the acquisition of capabilities in such target areas would also be beneficial.

### SUMMARY OF THE INVENTION

In light of the problems attendant in transforming the capabilities, structures and other elements of business organizations to meet competitive demands, it is an object of one or more embodiments of the present invention to provide a tool comprising related methods and processes that allow new operations or structures to be added to a business organization from outside business organizations, which methods retain the desirable characteristics of a merger or acquisition but have the speed of realization typically provided by traditional outsourcing approaches.

Furthermore, it is an object of one or more embodiments of the present invention to provide methods that limit the destruction of value within or provided by one or more target elements of a target business organization, which target business organization is being acquired or merged into another business organization.

Also, it is an object of one or more embodiments of the present invention to provide methods that enable a business organization to transform its business assets, skills, and capabilities by merging with or acquiring other business organizations that possess key elements, but which also enable the business organization to realize benefits from the merger or acquisition in an accelerated manner.

In response to these and other objects and needs, the various embodiments of the present invention as hereafter described provide a tool for transforming a business organization through various methods for preserving one or more target elements of an acquired target business organization by outsourcing those target elements during the integration period that follows the merger or acquisition. A business organization having a management that has recognized a need to transform its organization can identify a target organization that has one or more elements, including assets, skills and capabilities, that make it attractive for either a possible outright acquisition or merger as a vehicle through which to transform. Of particular interest to the business organization that desires transformation (i.e., the “transforming” business organization could be a particular target element that within the target business organization that fulfills a particular need that management of the transforming business organization hopes to satisfy through its desired transformation.

According to embodiments of the present invention a transforming business organization will desire to merge with or acquire a target business organization, and will have a particular desire to obtain the benefits of one or more target elements, which elements may be any series or set of assets, skills or capabilities relevant to the desired transformed business model. Notably, if these target elements were left under the control of the target business organization during the entire post-merger integration period, or transferred to the control of transforming business organization over time through conventional post-merger/acquisition integration mechanisms, it is likely that significant time will pass before the transforming business organization will be integrated with the operations or structure of the target business organization to an extent sufficient to permit the transforming business organization to experience substantially benefits from the target element. Furthermore, it is possible that the target element in particular, and the target business organization as a whole, will lose some inherent value, whether through neglect, stagnation, personnel losses, or otherwise, during the extended integration process as it is commonplace for mergers and acquisitions to cause the destruction of value.

Therefore, according to embodiments of the present invention, the involved business organizations arrange for control of one or more of these target elements to be transferred from its original business organization and be managed as an outsourced project or service by an outsourcing management organization that treats the remaining business organizations as “clients”. Such an outsourcing management organization would typically be a consulting firm or an appropriate service provider that specializes in the management of the outsourced asset, skill or capability.

Once a target element is successfully transferred to the outsourcing management organization, that outsourcing management organization can begin to focus upon the task of delivering benefits of the target element to both the transforming business entity and the target business entity. Beneficially, the resources necessary to adapt and run the target element's underlying assets, skills and/or capabilities are focused solely on managing the outsourced target element for the benefit of both original companies (or corresponding portions thereof) during the post-merger integration, and are not otherwise burdened with or distracted by issues relating to any ongoing merger integration efforts. Thus, it is possible for a transforming business organization, comprised of two or more not-completely integrated portions derived from elements of the original business organizations, to begin receiving benefits from the outsourced target elements at a relatively earlier time after post-merger or post acquisition integration activities are begun.

A particular organization established to outsource a target element could include a service provider comprised of management/employees of one of the original business organizations (the transforming business organization or the target business organization), or can be provided by a specialist or specialist organization (such as a consulting firm or service provider knowledgeable in managing outsourcing transitions). Assets or personnel can be assigned to the outsourcing management organization from either the transforming business organization or the target business organization depending upon the circumstances. In addition, the outsourcing management organization's or service provider's expertise in managing the target element would enable it to retain key people, make sound decisions that preserve the capability, and operate the element for the benefit of the acquiror's business. Hence the value of that element would not be lost to the acquiror.

According to embodiments of the invention, a resulting transformed business organization is provided with several options once the merger or acquisition integration is successfully completed. The transformed organization can elect to internalize the entire outsourcing management organization, where the functions, assets and personnel providing the target element, and run by the outsourcing management organization, are re-integrated into the business structure and direct control of the transformed organization. Similarly, certain members of the third party specialist or service provider could be invited on a contract basis to help run the new group, division, etc., as an external management team within the transformed organization. Also alternatively, the transformed organization can elect to maintain outsourcing of the target element, such as in situations where the current outsourcing arrangement has been found to be working particularly well.

According to an additional alternative embodiments of the present invention, the transforming business organization may acquire and retain target business organizations as separate entities, such as a wholly owned subsidiaries or a sister corporations. In such circumstances, target elements could remain outsourced or could be reintegrated back into any one of the original business organizations.

Also, according to additional alternative embodiments of the present invention, situations can arise where the business organizations involved in the merger or acquisition adopt hybrid roles. In many merger situations, the classification lines between the transforming business organization and a target business organization can be blurred, with each involved organization desiring transformation and seeing something to gain from the other organization. In this regard, target elements could be outsourced according to the present invention from any of the involved organizations in order to speed realization of benefits to all organizations and to protect the elements from adverse consequences of the transition and integration period.

Embodiments of the invention also include processes for preserving particular target element assets, skills, or capabilities of an original business organization during a merger or acquisition integration through outsourcing. Such processes include the transforming business organization identifying a particular business transformation need, and then identifying an appropriate target business organization that can satisfy the need for transformation through a merger or acquisition. In situations where a suitable target business organization is identified that can provide the desired asset, skill, or capability, target element preservation processes according to the present invention commence to outsource the target elements to be managed by a suitable outsourcing management organization.

After the one or more target elements have been successfully outsourced, such target element preservation processes permit the transforming business organization(s) and the target business organization(s) to begin to utilize and receive the benefits of the outsourced target element(s). Notably, this would typically occur according to embodiments of the present invention during ongoing integration and transition efforts of the two or more original organizations. In this manner, early and preserved benefits of the outsourced elements can be received relatively quickly by all involved business organizations.

Processes according to embodiments of the present invention conclude with the resulting transformed business organization or organizations adopting a final structure for each outsourced target element.

The various features of the invention having thus been described, preferred embodiments thereof will hereafter be described in detail with respect to several drawings.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1A through FIG. 1F are schematic diagrams depicting the various stages of the integration of two original business organizations into a new transformed organization and the outsourcing of a target skill or capability within one of the original business organizations during the integration according to embodiments of the present invention;

FIG. 2 is a flow diagram depicting a process for preserving a target capability or element of an original business organization during a merger or acquisition integration through outsourcing in accordance with embodiments of the present invention; and

FIG. 3 is a flow diagram depicting a process for establishing the outsourcing of a target capability or element during a merger according to one embodiment of the present invention.

### DETAILED DESCRIPTION OF THE PREFERRED EMBODIMENTS

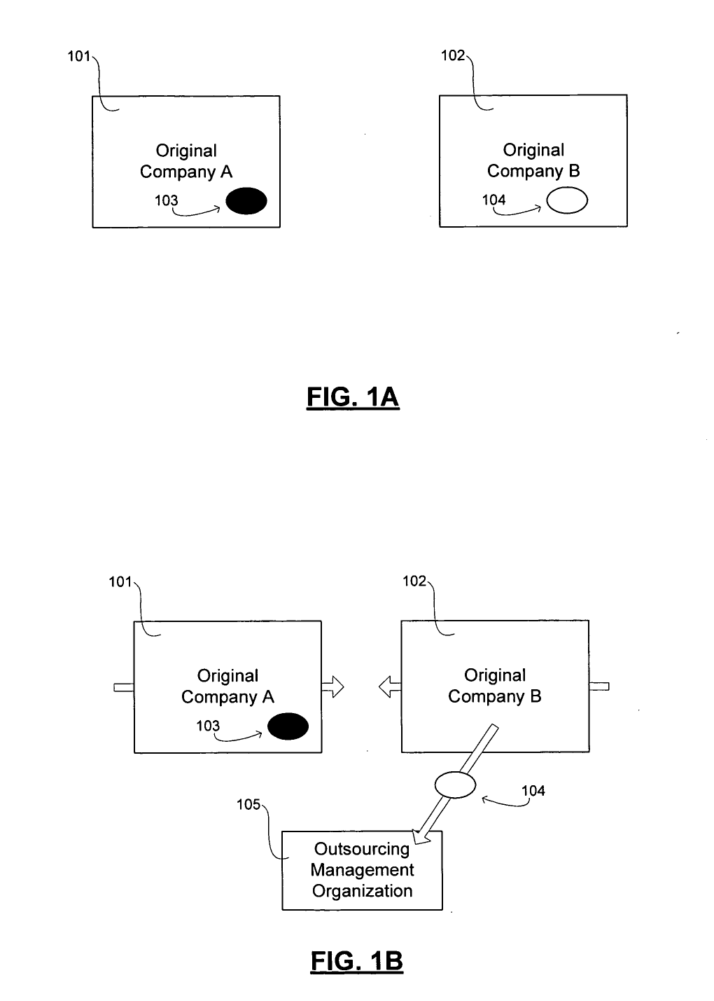

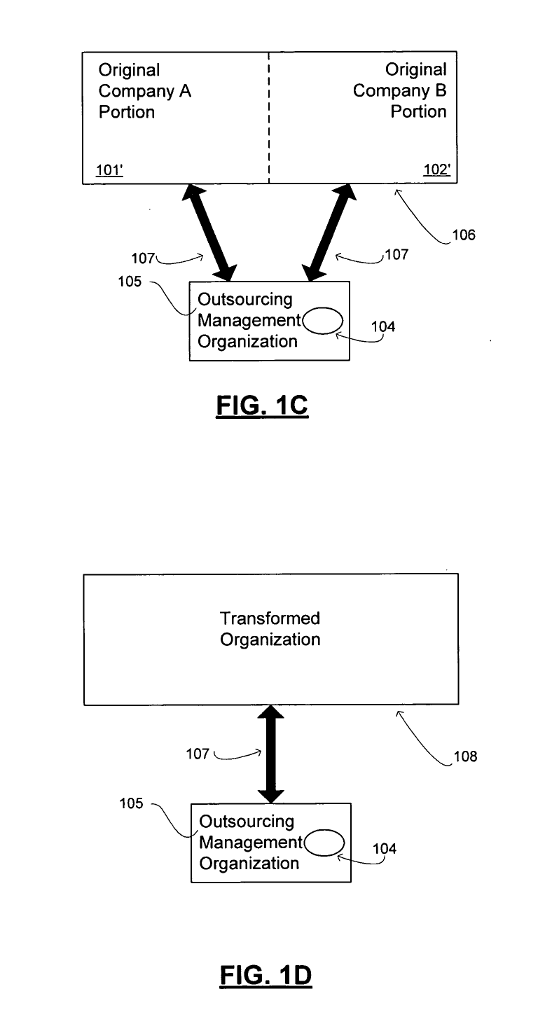

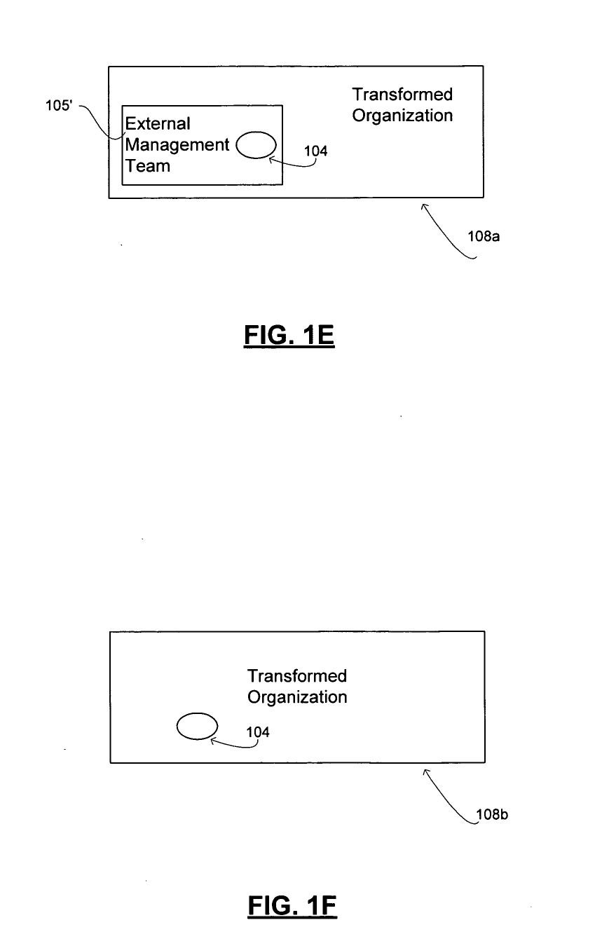

The diagrams of FIG. 1A through FIG. 1F depict the various stages of the integration of two original business organizations, a transforming business organization and a target business organization, into a new transformed organization by utilizing outsourcing strategically implemented according to an asset, skill and capability preservation process according to embodiments of the present invention.

FIG. 1A is a schematic diagram showing the pre-merger or pre-acquisition stage of two business entities. Original Company A 101 as depicted in this figure is a business organization having a management that has recognized a need to transform its organization. Original Company B 102 is a business organization that may or may not be considering transformation, but which has one or more elements, including assets, skills and capabilities, that make Original Company B 102 attractive (for either a possible outright acquisition or merger) to Original Company A 101. Of particular interest to Company A 101 could be a particular target element 104 that fulfills a particular need 103 of Original Company A 101, which need the management of Company A 101 hopes to satisfy through its desired transformation.

FIG. 1B schematically depicts the status of Company A 101, which may be generically referred to herein as a “transforming” business organization, and Company B 102, which may be generically referred to herein as a “target” business organization, as a merger or acquisition is initiated to join the two business organizations together. As shown in the figure, according to embodiments of the present invention Company A 101, the transforming business organization, desires to merge with (or acquire) Company B 102, the target business organization, and Company A 101 has a particular desire to obtain the benefits of target element 104 (potentially among other target elements that are not depicted), which element may be any series or set of assets, skills or capabilities relevant to the desired business model of Company A. As noted above, if target element 104 was to be left under the control of Original Company B 102 during the entire post-merger integration period, or transferred to the control of Company A 101 over time through conventional post-merger/acquisition integration mechanisms, it is likely that over a year will pass before the transforming business organization will be integrated with the operations or structure of the target business organization to an extent sufficient to permit the transforming business organization to enjoy any substantial benefits from the target element. Furthermore, it is possible that the target element in particular, and the target business organization as a whole, will lose some inherent value, whether through neglect, stagnation, personnel losses, or otherwise, during the extended integration process as it is commonplace for mergers and acquisitions to cause the destruction of value. According to embodiments of the present invention, therefore, companies 101 and 102 arrange for control of target element 104 to be transferred from Original Company B 102 as depicted, such that it may then be managed as an outsourced project or service by an outsourcing management organization 105 (with both Original Company A 101 and Original Company B 102 as “clients”). Outsourcing management organization 105 would typically be a consulting firm or an appropriate service provider that specializes in the management of the outsourced asset, skill or capability.

Once a target element is successfully transferred to the outsourcing management organization, that outsourcing management organization can begin to focus upon the task of delivering benefits of the target element to both the transforming business entity and the target business entity. Beneficially, the resources necessary to adapt and run the target element's underlying assets, skills and/or capabilities are focused solely on managing the outsourced target element for the benefit of both original companies (or corresponding portions thereof) during the post-merger integration, and are not otherwise burdened with or distracted by issues relating to any ongoing merger integration efforts. Thus, as depicted in FIG. 1C, it is possible for a transforming business organization 106, comprised of two not-completely integrated portions 101′ and 102′ (corresponding to elements derived from the balance of Original Company A and Original Company B, respectively), to begin receiving benefits 107 from the target element 104 at a relatively earlier time after the merger integration began. These benefits 107 can be received up until the time that the merger integration process is completed and a single transformed organization 108 is successfully established, as depicted in FIG. 1D. At this point, as is discussed more fully below with respect to FIG. 1E and FIG. 1F, the resulting transformed business organization 108 must decide how the currently outsourced target element 104 will be handled now that the post-merger integration efforts are completed.

A particular organization established to outsource a target element could be run by and/or include candidates selected from the management/employees of one of the original business organizations (the transforming business organization or the target business organization), or candidates can be provided by a specialist or specialist organization (such as a consulting firm or service provider knowledgeable in transitioning and managing capabilities such as the target element in outsourcing transactions). Assets or personnel can be assigned to the outsourcing management organization from either the transforming business organization or the target business organization depending upon the circumstances.

This outsourcing of one or more target elements during the integration period that necessarily follows a merger or acquisition deal creates various inherent advantages over the traditional merger, acquisition, or outsourcing approaches as described above, and these advantages help to deliver benefits of the target element in speedy fashion and with undiminished quality. A primary advantage is that the outsourcing of the target element can have beneficial psychological impacts upon key employees in comparison to traditional situations. Instead of employees relevant to the target element remaining isolated in their original work environment and feeling like additional (and what can potentially be viewed as being unreasonable) tasks and responsibilities are being heaped upon them, outsourcing provides a mechanism to change the perspective of these important personnel assets. In this regard, employees can more readily be convinced to accept a change in role when organizational structure is changing, and these changes in role can be used to reassure them of the importance of their efforts to the success of both companies (their original employer and resulting organization(s) following the merger or acquisition).

Moving appropriate personnel associated with the target element over to a new entity managed by an outsourcing management organization helps convey, in a reassuring manner, that things may not be the same in their job and responsibilities, but that the changes being made are necessary and important. Employees working under the newly established outsourcing management organization can be provided with an immediate sense of new organizational purpose, making them more ready to accept that what they were doing before the outsourcing has changed from that point onward.

Notably, employees in such merger situations may feel unsettled or unwanted by having their department, business unit, group, or the like split off from the direct management structure of their original employer. Thus, it is important in many circumstances to provide employees that are being asked to join the outsourced organization a feeling of choice (such as by enticing certain key employees with employment contract having certain guarantees, or with options to rejoin their original employer organization in a similar and/or new capacity after assisting the outsourcing management organization for a certain period of time) and a feeling of importance (by explaining to those employees how important their efforts are to the strategic success of both organizations). As such, outsourcing of a target element as herein described can forestall the flight of talented individuals who are otherwise made uneasy by the atmosphere of uncertainty and often rumor caused by the merger or acquisition.

An additional advantage provided by outsourcing of one or more target elements during a merger or acquisition integration is the avoidance of political issues that may arise between the competing management of the transforming business organization and the target business organization. Specifically, these political issues can lead to various problems where the pre-existing management of one of the original organizations is not willing to readily defer to the expertise or leadership of management from the other original organization. Notably, this issue would be greatly exacerbated in situations where, as is commonly present in utilization of the present invention, the management or personnel of a target business organization being acquired has more experience in a particularly desirable target area when compared to the management of the transforming business organization, who would traditionally be installed as their bosses. Utilization of a outsourcing management organization outside of both pre-existing business organizations allows for more flexibility within leadership roles and structures, and has the benefit of preventing involved personnel from viewing changing of role definitions as demotions or snubs, or from being subjected to oversight by and poor decision of bosses with less expertise.

The following example is provided to illustrate the use of the invention as described above with respect to FIG. 1A through FIG. 1D. Suppose there is a first business organization which is a large, but traditionally family-owned, chain of grocery stores with a presence concentrated in a first geographic market, such as the northeast United States. A second business organization, which is also a large chain of grocery stores, has a primary presence in a second geographic market, such as the mid-atlantic United States, and also has a lesser, secondary presence that extends into the northeast United States geographic market. The first business organization is considering purchasing the second business organization for various reasons. First, the second business organization has been suffering from poor management over the last several years and is available for sale at an attractive price, providing the first business organization with a good inroad into establishing retail locations the mid-atlantic geographic market. Second, the first business organization wants to modernize its supply chain and stock management systems to include modern integrated real-time inventory management and re-stocking technology, which the second grocery chain already has implemented within the last two years to good competitive advantage.

Outsourcing of the processes, personnel, and assets associated with the desirable inventory management and re-stocking technology of the second grocery chain immediately after a merger or acquisition deal is completed in accordance with embodiments of the present invention in these circumstances will enable the transforming business organization, i.e., the first grocery chain, to obtain benefits from the target element's assets, skills or capabilities relatively quickly without risking damaging this particularly desirable element. The first grocery chain may have superior management generally speaking (as reflected by its stronger financial position), but its management will necessarily know less with respect to properly utilizing modern inventory management and re-stocking technology. In a traditional merger or acquisition, however, political reasons could keep the more knowledgeable personnel of the second grocery chain from gaining leadership positions with respect to transforming the inventory management technology of the stores that were operated by the first grocery chain. In essence, the less knowledgeable persons, those coming from the purchaser organization (i.e., the first grocery store chain) as opposed to the purchasee organization (i.e., the second grocery store chain), would more likely be put in command positions in a traditional acquisition or merger situation.

A third party outsourcing management organization, such as a consulting firm or service provider business with particular expertise in the area of supply chain management technology, would not feel as pressured by many of these political difficulties as they would be external to both original business organizations, and, in any event, would responsive to both organizations to the extent dictated by the deal in their roles as customers. The outsourcing management organization would be able to identify and retain key trained and/or qualified people from either or both original organizations and have them work under the general supervision, guidance or direct management of the outsourcing management organization's in-house experts. While it is likely that these key people would likely come primarily from the second business organization (i.e., the organization having the target element needed by the other organization as part of its transformation), with outsourcing it is possible to more easily meld select personnel from various original organizations to obtain the desired combination of specific expertise.

Once the target element is successfully outsourced to an external operation that is up and running, the first grocery chain likely will still be proceeding with the early stages of its integration of the purchased second grocery chain. The first grocery store chain will be on track to receive all the benefits (such as retail locations) in the long term that it hoped to receive from the acquisition once the integration is completed, but will also be able to realize benefits more immediately from the supply chain management technology resources being managed as an outsourced entity. Thus, for the critical period during the integration of the purchaser and purchasee organizations, the targeted technology resources of the second grocery chain are largely insulated from the upheaval and negative side effects created by the integration efforts.

Thus, the present invention avoids situations where key personnel are being moved around and being put to work under persons that they may feel do not understand their contributions very well or possibly even do not trust them, and, as a result, do not provide good support or make good decision that enable them to create the most value for the combined organization. This limits the chances that these key personnel resources will seek to leave for a new position somewhere else, if at all, before a transition to servicing both the target business organization and the transforming business organization is made. By this time, a sufficient amount of transformation could have taken place to instill new business processes and structures that will adequately support the resulting transformed business organizations.

Referring now back to FIG. 1D, it is possible that a transformed organization 108, once the merger or acquisition integration is successfully completed, will not want to keep the target element 104 outsourced by organization 105 on a permanent basis. As mentioned above, among other reasons, companies may be unwilling to entrust the handling of key drivers of their business models to contracted third parties on a permanent basis. Once an integration is completed and the transformed organization 108 and outsourcing merger organization 105 reach the stage as depicted in FIG. 1D, they are confronted with the choice of three options. The transformed organization can elect to internalize the entire outsourcing management organization as depicted in FIG. 1E, where the functions, assets and personnel comprising the target element 104 as run by the outsourcing management organization are brought back within the business structure and ultimate control of the transformed organization. In this case, however, certain members of the third party specialist or service provider would be invited on a contract basis to help run the new group, division, etc., as an external management team 105′ within the transformed organization 108a.

As a second alternative (which may be gradually transitioned into from through the stage depicted in FIG. 1E), the transformed organization 108b can completely re-internalize the outsourced target element as depicted in FIG. 1F. In many cases, this stage would at least initially be the expected final outcome of the managers when it first is decided to outsource the target element. The final alternative, of course, would be where the transformed organization 108 elects to maintain outsourcing of the target element 104 as depicted in FIG. 1D, such as where it has been found to be working particularly well.

While not depicted in any of FIG. 1A through 1F, it is of course possible according to embodiments of the present invention for the transforming business organization to acquire and retain the target business organization as a separate entity, such as a wholly owned subsidiary or a sister corporation. In such circumstances, the target element could remain outsourced or could be reintegrated back into either one of the original business organizations. Also while not depicted, it will be readily apparent to one of ordinary skill in the art that the transforming organization and the target organization optionally can outsource more than one target element in similar manner if it is desired for the two companies to have immediate access to the benefits of those target elements. Each such target element could be considered and treated independently (to the extent they were separable) according to the target element preservation process as described below. Further, the above description of the operation of the present invention can be readily adapted by one skilled in the art to a situation where three or more business organizations are involved in the merger or acquisition deal and are desired to receive benefits from the outsourced target element(s).

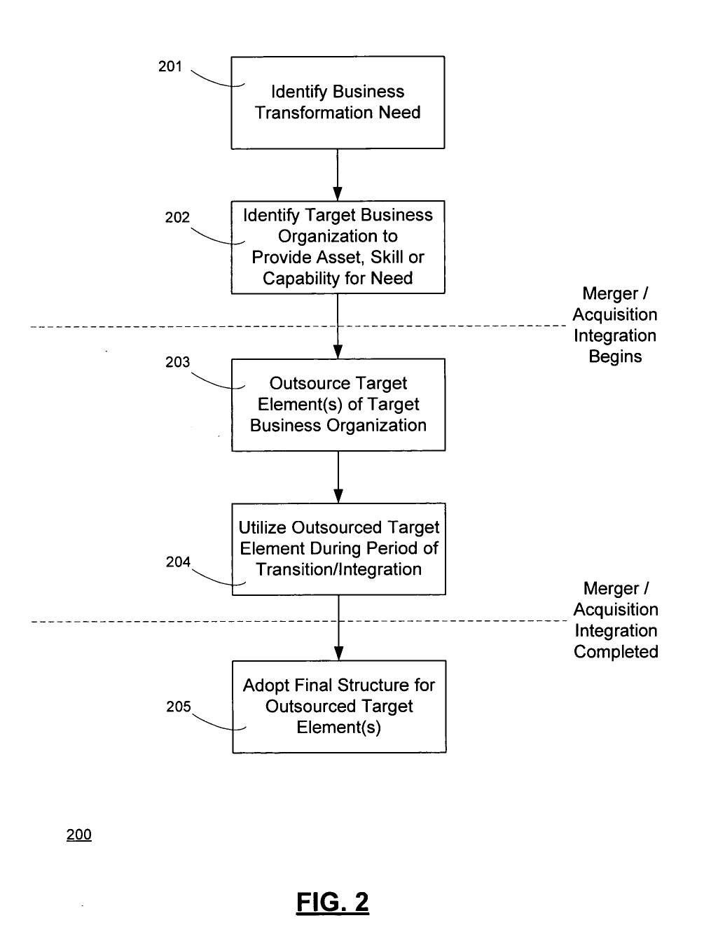

FIG. 2 depicts in flow diagram form a target element preservation process 200 for preserving particular assets, skills, or capabilities of an original business organization during a merger or acquisition integration through outsourcing in accordance with one embodiment of the present invention. Process 200 begins during a period before the merger or acquisition is initiated with step 201, comprising the transforming business organization identifying a particular business transformation need. As described above, this need would comprise change to the organization's fundamental underlying processes, technology, culture and/or way of doing business in order to improve the organization. This could be by, for example, reducing costs, improving return-on-investment and/or creating capabilities for new or modernized programs and services. For example, a specialty retail goods producer could identify a need to develop distribution channels and direct sales capabilities in order to increase sales volume and obtain better margins.

Once a business transformation need is identified, the transforming business organization at step 202 will need to identify an appropriate target business organization that can satisfy the need for transformation through a merger or acquisition. It should be readily appreciated by one skilled in the art, therefore, that the present invention cannot be advantageously employed in every situation where a business organization desires to undergo transformation. In many circumstances, a suitable target company viable for merger or outright acquisition may not always be available. In cases however, where a suitable target business organization is identified that can provide the desired asset, skill, or capability, the target element preservation process 200 can proceed into the post-merger or post-acquisition integration stage as depicted.

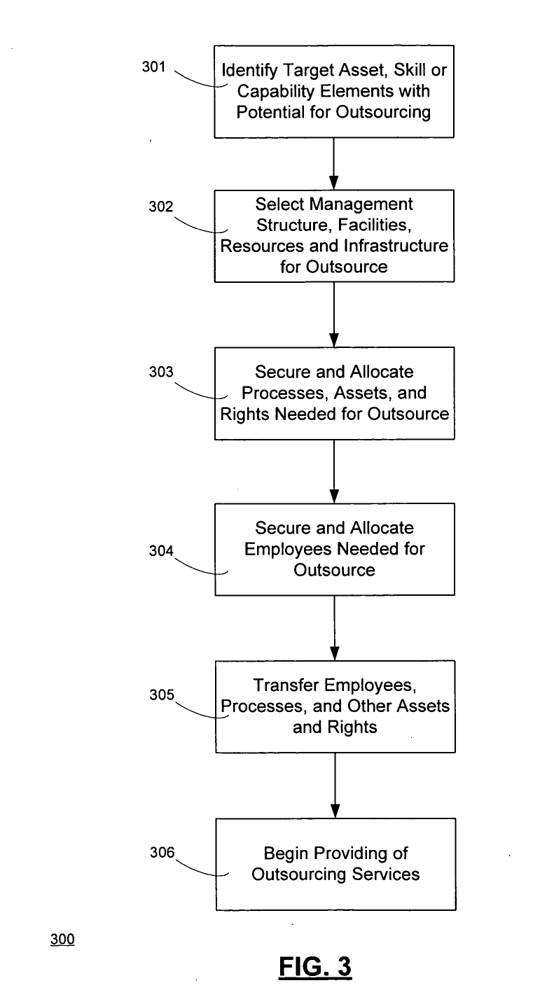

Following step 202, the actual post-merger or acquisition integration efforts of the involved organizations would commence (i.e., after the closing on the controlling merger or acquisition deal). Next, in step 203, the involved business organizations begin the task of outsourcing any appropriate target elements. The flow diagram of FIG. 3 depicts a target element outsourcing process 300 for use in conjunction with a merger or acquisition in accordance with one embodiment of the present invention.

Referring now to FIG. 3, process 300 begins at step 301 with management identifying those target elements, which may include sets of interrelated assets, skills, or capabilities, that have potential for advantageous outsourcing according to the present invention. Notably, those elements that would be considered to have potential for outsourcing would be those that appear likely to be able to be outsourced readily from the target organization without significantly upsetting the other operations of that organization. Further, an element would be a better candidate for outsourcing according to the present invention if the transforming business organization would benefit significantly from immediate exploitation of the various assets, skills and capabilities.

While it generally has been described herein that target elements will belong to an identifiable target business organization or company, one of ordinary skill in the art will understand that this concept can also be readily applied to situations where various different original organizations involved in a given merger or acquisition can have such target elements. In many merger situations, the classification lines between the transforming business entity and a target business entity can be blurred, where each involved organization is desiring transformation and sees something to gain from the other organization. In this regard, target elements could be outsourced from any of the involved organizations in order to speed realization of benefits to all organizations and to protect the elements from adverse consequences of the transition and integration period.

After potential target elements (and their constituent assets, skills and capabilities) have been identified, management of the involved business organizations would begin to lay out the plans for the outsourcing project at step 302 by investigating and selecting an appropriate management structure, facilities and general infrastructure needed to support the outsource. At this step, management would be, for example, researching and interviewing organizations (such as consulting groups or outsourcing services providers) that could assist in running an outsourced management organization for each target asset, considering service level agreements and reimbursement structures to make the outsource work, and considering which resources (personnel, assets, etc.) should be allocated to a given outsourcing effort. Notably, at this time the involved business organizations may determine that a particular target element is not feasible for outsourcing and adjust their strategy accordingly.

After the involved business organizations have laid their plans at step 302, they would need to begin the task of actually making the outsourcing effort happen. At step 303, the involved business organizations would need to secure and allocate the processes, assets, and rights needed for the outsource. This, for example, may involve assigning contract rights or licensing trade secrets, expertise, or other necessary know how to the outsourcing management organization. Additionally, at step 304, the involved business organizations would need to secure and allocate the key employees needed for the outsource. As identified above, certain employees, including management and skilled labor, can comprise a large portion of the value inherent in any target element, and getting these employees willingly and intimately involved in the outsourcing effort can be a difficult, yet important task. Understandably, an inability to secure necessary key employees also could be a factor that makes outsourcing according to the present invention unsuitable.

Thereafter, step 305 of process 300 actually initiates the commencement of the outsourcing effort with the transfer of assets to the control of the outsourcing management organization, including employees, processes, and other rights. Thereafter, the outsourcing management organization would begin providing outsourcing services to appropriate business organizations according to the relevant outsourcing agreement at step 306.

While target element outsourcing process 300 as depicted in FIG. 3 has been described above as roughly corresponding to step 203 of FIG. 2, it should be understand that various steps of process 300 are preparative in nature. In particular, steps 301 through 304 could be done in advance of a merger or acquisition deal being finalized or even agreed upon (i.e., roughly coextensive with step 202 of FIG. 2) if outsourcing of one or more particular target elements is considered to be a key element of the transaction.

Referring again back to FIG. 2, after the one or more target elements have been successfully outsourced, the target element preservation process 200 continues at step 204 with the transforming business organization and the target business organization beginning to utilize and receive the benefits of the outsourced target element. Notably, as depicted in FIG. 2, step 204 would typically occur according to embodiments of the present invention while the integration and transition efforts of the two original organizations are still in progress. In this manner, early and preserved benefits of the outsourced elements can be received relatively quickly by all involved business organizations.

Finally, process 200 concludes at step 205 where the resulting transformed business organization or organizations are left with the task of adopting a final structure for each outsourced target element. As described above, this can include deciding to retain the target element in a outsourced status (either retaining the same or selecting different service providers or adjusting service level agreements as necessary), deciding to re-internalize the target element into the resulting transformed business organization(s), or deciding to adopt a hybrid approach by re-internalizing the exported assets and resources but retaining an external management team as contractors to help run the newly re-integrated group/team/division/etc. (for at least the short term).

As will be readily understood by one of ordinary skill in the art, the above schematic diagrams and flow charts are meant to be illustrative of preferred operation of the transformation tools and related methods according to the present invention. Thus, the particular elements of the illustrated embodiments, including the number, ordering and relationship of the various steps, could be modified in various insubstantial ways while still providing tools and processes according to the present invention.

The foregoing description of the preferred embodiments of the invention has been presented for the purposes of illustration and description. It is not intended to be exhaustive or to limit the invention to the precise form disclosed. Many modifications and variations are possible in light of the above teaching. It is therefore intended that the scope of the invention be limited not by this detailed description, but rather by the claims appended hereto.

1. A method for transforming business organizational structures and operations through outsourcing integration of mergers and acquisitions, said method comprising:
identifying a particular business transformation need of a transforming business organization, said need including individual needs for acquisition of particular assets, skills, or capabilities;
identifying an appropriate target business organization that can satisfy said business transformation need through a merger or acquisition;
initiating a merger or acquisition transaction involving said transforming business organization and said target business organization;
outsourcing at least one target element of the target business organization at a beginning of integration of said business organizations, said target element comprising at least a portion of said needed assets, skills or capabilities, wherein resources relating to said target element are thereby managed by an outsourcing management organization that is external to said first business organization and said target business organization; and
utilizing said outsourced target elements for the benefit of the transforming business entity during said integration.

2. The method according to claim 1, wherein said outsourcing management organization is a service provider that specializes in the management of the outsourced needed assets, skills or capabilities.

3. The method according to claim 1, wherein said outsourcing management organization is a business organization operated by a consulting firm that will manage said needed assets, skills or capabilities.

4. The method according to claim 3, wherein said consulting firm will manage said outsourcing business organization at least until completion of said integration.

5. The method according to claim 1, wherein said outsourcing business organization is operated by personnel taken in part from said target business organization.

6. The method according to claim 1, wherein said target elements each comprise a series or set of assets, skills, or capabilities that are relevant to a desired transformed business model of said transforming business organization.

7. The method according to claim 1, further comprising transferring control of at least one of said target elements to a resulting transformed business organization following completion of said integration.

8. The method according to claim 7, wherein said transformed business organization comprises a business organization created as a result of said merger or acquisition.

9. The method according to claim 7, wherein said at least one of said target elements is incorporated internally within the structure of said transformed business organization and specialists are contracted to oversee the management of said target element within said transformed business organization.

10. The method according to claim 9, wherein said specialists oversee the management of said target element until an internal management team is sufficiently trained in the operation of said target element as a part of said transformed business organization.

11. The method according to claim 9, further comprising transferring control of said outsourced target elements permanently to said transformed business organization for continued management following completion of said integration.

12. The method according to claim 1, further comprising utilizing said outsourced target elements for the benefit of said target business entity during said integration.

13. The method according to claim 1, wherein said outsourcing of said target element further comprises:
identifying one or more target elements within said target business organization that are desirable for outsourcing;
investigating and selecting an appropriate management structure, facilities and general infrastructure needed to support an outsourcing effort of said identified target elements;
securing and allocating any processes, assets, and rights within said outsourcing business organization and within said target business organization that are needed for the outsourcing effort;
securing and allocating any key personnel within said outsourcing business organization and within said target business organization that are needed for the outsource; and
initiating commencement of said outsourcing effort by transferring said secured and allocated processes, assets, rights and key personnel to the control of the outsourcing management organization.

14. The method according to claim 13, wherein said securing and allocating of said processes, assets, and rights includes activities selected from the group consisting of assigning necessary contract rights, and licensing trade secrets, expertise, or other necessary know how to the outsourcing management organization.

15. The method according to claim 13, wherein said investigating and selecting includes activities selected from the group consisting of researching and interviewing organizations that could assist in running an outsourcing management organization for each target element, considering service level agreements and reimbursement structures to make the outsourcing effort work, and considering which resources should be allocated to said outsourcing management organization.

16. The method according to claim 13, wherein said target elements are desirable for outsourcing if those elements appear likely to be able to be outsourced readily from said target organization without significantly upsetting other operations of said target organization.

17. A method for preserving particular assets, skills, or capabilities of an original business organization during a merger or acquisition integration, said method comprising:
a first business organization identifying a particular business transformation need, said need including individual needs for acquisition of particular assets, skills, or capabilities;
said first business organization identifying an appropriate target business organization that can satisfy the business transformation need through a merger or acquisition;
said first business organization merging with or acquiring said target business organization;
outsourcing at least one target element of the target business organization at the beginning of said integration, said target element comprising at least a portion of said assets, skills or capabilities which said first business organization desires to preserve during said integration, wherein resources relating to said target element are thereby managed by an outsourcing management organization that is external to said first business organization and said target business organization; and
said first business organization beginning to utilize and receive benefits from said outsourced target elements.

18. The method according to claim 17, wherein said outsourcing management organization is a service provider that specializes in the management of the outsourced needed assets, skills or capabilities.

19. The method according to claim 1, wherein said outsourcing management organization is a business organization operated by a consulting firm that will manage said needed assets, skills or capabilities.

20. The method according to claim 19, wherein said consulting firm will manage said outsourcing business organization at least until completion of said integration.

21. The method according to claim 17, wherein said outsourcing business organization is operated by personnel transferred in part from said target business organization.

22. The method according to claim 17, wherein said target elements each comprise a series or set of assets, skills, or capabilities that are relevant to a desired transformed business model of said first business organization.

23. The method according to claim 17, further comprising transferring control of at least one of said target elements to a resulting transformed business organization following completion of said integration.

24. The method according to claim 23, wherein said transformed business organization comprises a business organization created as a result of said merger or acquisition.

25. The method according to claim 23, wherein said at least one of said target elements is incorporated internally within the structure of said transformed business organization and specialists are contracted to oversee the management of said target element within said transformed business organization.

26. The method according to claim 25, wherein said specialists oversee the management of said target element until an internal management team is sufficiently trained in the operation of said target element as an internal part of said transformed business organization.

27. The method according to claim 25, further comprising transferring control of said outsourced target elements permanently to said transformed business organization for continued management following completion of said integration.

28. The method according to claim 17, further comprising utilizing said outsourced target elements for the benefit of said target business entity during said integration.

29. The method according to claim 17, wherein said outsourcing of said target element further comprises:
identifying one or more target elements within said target business organization that are desirable for outsourcing;
investigating and selecting an appropriate management structure, facilities and general infrastructure needed to support an outsourcing effort of said identified target elements;
securing and allocating any processes, assets, and rights within said outsourcing business organization and within said target business organization that are needed for the outsourcing effort;
securing and allocating any key personnel within said outsourcing business organization and within said target business organization that are needed for the outsource; and
initiating commencement of said outsourcing effort by transferring said secured and allocated processes, assets, rights and key personnel to the control of the outsourcing management organization.

30. The method according to claim 29, wherein said securing and allocating of said processes, assets, and rights includes activities selected from the group consisting of assigning necessary contract rights, and licensing trade secrets, expertise, or other necessary know how to the outsourcing management organization.

31. The method according to claim 29, wherein said investigating and selecting includes activities selected from the group consisting of researching and interviewing organizations that could assist in running an outsourcing management organization for each target element, considering service level agreements and reimbursement structures to make the outsourcing effort work, and considering which resources should be allocated to said outsourcing management organization.

32. The method according to claim 29, wherein said target elements are desirable for outsourcing if those elements appear likely to be able to be outsourced readily from said target organization without significantly upsetting other operations of said target organization.
